(19) United States
(12) Patent Application Publication
(10) Pub. No.: US 2002/0056119 A1
(43) Pub. Date: May 9, 2002

(54) Personal video channel system

(76) Inventor: Michael W. Moynihan, Washington, DC (US)

Correspondence Address: FULBRIGHT & JAWORSKI, LLP, 666 FIFTH AVE, NEW YORK, NY, 10103-3198, US

(21) Appl. No.: 09/747,566

(22) Filed: Dec. 22, 2000

Related U.S. Application Data
(60) Provisional application No. 60/173,041, filed on Dec. 23, 1999.

(51) Int. Cl. H04N 7/173

(52) U.S. Cl. 725/87

(57) ABSTRACT

A method and system for a company, group or individual to easily and advantageously transfer multimedia files to a central server where they can be readily accessed by others on the network. In accordance with an embodiment of the present system, users can create and publish multimedia to a wide audience in seconds, a task that formerly might have taken weeks or, indeed, been impossible to achieve. Once the multimedia is published, an embodiment of the present system further provides integrated tools to manage, publicize, edit, charge for and control access to the multimedia. Elements comprising an embodiment of the present system include the Personal Producer software, Media Mogul software, V-Mail software, Personal Channels, Business Channels, Personal Stores and other software.

### RELATED APPLICATIONS

This application is a continuation-in-part of U.S. Provisional Patent Application Ser. No. 60/173,041, filed Dec. 23, 1999, which is incorporated by reference herein in its entirety.

### FIELD OF THE INVENTION

The invention relates to the field of data management on a computer network, specifically the display and management of multimedia files on a network and their use in commerce.

### BACKGROUND OF THE INVENTION

The explosive growth of the Internet has vastly expanded the ability to share information over networks. Whereas once, it was an accomplishment to share a few words of text, people now routinely share images and even audio and video. Many web pages on the World-Wide-Web as well as private networks now feature one or more images. But whereas text and images can be readily presented on a screen for viewing it is a more complex matter to display audio or video.

It is not sufficient to simply place a hot link to an audio or video on a page. Web browsers can render text and images but cannot automatically render video imagery without the use of plug-ins or separate applications. In addition, due to the huge size of video files relative to text, it is desirable to compress the video file to accelerate transfer to the client. However, is by no means a trivial matter to compress the size of the file or convert it into a format suitable for transmission. As a result, the technological requirements surrounding rich media currently impose barriers to anyone wishing to making it available to others on a network.

Moreover, as already stated, rich media such as video and audio use far more memory than text. The other principal method of sharing information besides displaying it is to simply send the entire file to someone else, by moving it, copying it, or by attaching it to an e-mail. However, video files are so large that they cannot be transmitted rapidly over most connections. A one minute .avi movie clip that is four megabytes in size could take twenty minutes to transfer over a dial-up network connection not counting the need to start over every time network problems break the connection. A full length movie could take days. Most e-mail programs also place limits on the size of file attachments. Thus, it is currently time consuming and impractical for users to swap large rich media files among one another.

To cope with bandwidth constraints, a technology known as streaming has arisen to send audio and video over networks bit by bit in a stream. While this technology facilitates the transfer of bits, as a client/server technology that requires a good deal of processing as well as bandwidth at the server end, it imposes a new barrier, however, since it requires the person displaying video to have the capacity to serve it to others.

To overcome these barriers to sharing rich media with others, a number of people have tried different approaches. One traditional approach is to allow people to setup web pages on servers that are configured to support serving of multimedia content. A number of ISPs allow customers to set up a web page and then FTP or mail multimedia files that they wish to place on the page.

This solution is imperfect, first on a general level, because it requires customers to find an ISP and perform a variety of technical tasks merely to create a web page. Second, and particular to multimedia, content providers must convert any audio or video files to streaming form and somehow manage to get the files to the ISP. Even when the page is up and running, the audio and video content is not indexed and there is minimal on-going maintenance capability. None of these services permit pay-per-view or other commerce capabilities that make use of the multimedia content.

An alternative solution, used by large media companies such as Time CNN.com an ABC.com involves negotiating arrangements with producer of content and then placing this content on the web-site. This method, however, does nothing to empower users of the network to display video and imposes editorial, contractual and other barriers to displaying video on the web. Also, companies such as Encoding.com, Intervu and Broadcast.com offer streaming services. None of these services, however, aggregate, index and display content on a single Web-site which would allow the content-producer to benefit from the externalities of being associated with prime content and the viewer to benefit from easy access to other content-related video.

A website called Freeserve.org enables people to send video clips to the site using File Transfer Protocol (FTP). However, the company does not offer the capability to directly send the video from the web page or the ability to convert files to streaming format or the ability to perform ongoing maintenance or commerce on the site. In addition, the display of video is not completely under user control.

None of these efforts succeeded in the basic goal of allowing owners or providers of content who are not technical experts to freely share multimedia documents over a network.

As aresult, the current state of affairs—bandwidth constraints combined with high technological barriers to distributing rich media over a network—have made it impossible for small clients to display home videos or business-related videos to others over a network in a cost effective way.

Also, a service providing an easy-to-use integrated system for organizing, editing, indexing, hosting, and displaying, multimedia files on a central server that enables the client to control how and to whom files are displayed on a network is desirable. Preferably, the system is flexible that it doesn't even require the client to have his own computer.

Therefore, a system that is simple and cost-effective to use is desirable, such that it enables amateurs, independent small businesses, not-for-profits, and the like to communicate using video over the Internet. Such a system would make it easy to upload video and broadcast (or narrowcast) it to the world, allowing the producer to edit and market the original content. Moreover, such a system would enable the owner of the intellectual property to protect it through a password and thus earn a return on the original production costs.

### SUMMARY AND OBJECTS OF THE INVENTION

The present invention provides away for people on a network to organize, edit, index, host and display multimedia files on a central server, while preserving control over how and to whom the files are displayed. The invention lets providers of multimedia edit, manage, update, charge for access to, and maintain their collection of media files on a central server. It does this by allowing people to move files to a virtual exhibition space on a server known as a Personal Video Channel, or the like, and then providing them with the tools to manage their space on an on-going basis. At this point, several hundred people have already signed up for this service.

In accordance with an embodiment of the present invention, the system transmits multimedia files to a server where the files are converted into a form that makes it easy for others to hear or view them.

Files are indexed using data provided by the participants or gleaned from the files themselves so that they become searchable according to various criteria. Files are then made accessible to viewers in a format and manner that the supplier of the files selects such as a personal channel, theater or store;

The content provider has the ability to customize the channel and set its look and feel.

The content provider has the ability to password protect the channel. In this manner, the user can be billed for usage in any manner desired, subscription information can be tracked and preserved, authorization levels can be set, and data protection to prevent unauthorized use can be accomplished.

The channel, theater or store is uniquely linked to the person or entity that created it by a unique domain name that the service will register for the content provider. In this way the content-provider can advertise and publicize the content;

Finally, the content supplier is provided with software to manage and edit the channel. This allows the content-provider to control how the content is displayed on an on-going basis.

The present invention enables the supplier of the files to gain the ability he or she would otherwise lack—to display files to everyone on the network, charge others to view the files, sell or auction off other goods and services using the files, describe the files, hide files from viewers, password protect files, add to or subtract from them, advertise and publicize them using video mail (i.e., V-Mail) and otherwise manage and maintain them. The supplier also gains the ability to name his or her channel, pay-per-view theater or store, customize it and set its look and feel. The channel, theater or store is uniquely linked to the person or entity that created it.

Accordingly, the present invention provides a way for users who lack the ability or resources to convert, index and serve video or other rich media on their own computers to nevertheless display rich media to others by uploading it to their own proprietary space on a specialized server. There the video is converted, indexed and streamed according to its provider's instructions and can be maintained and publicized on an on-going basis. In addition, by bringing multiple suppliers of content together at one location, the invention creates externalities that benefit all the suppliers since together they constitute a larger searchable magnet for viewers than they would alone.

For the individual or smaller player who is largely barred today from making multimedia available to others, the present invention solves the many problems that he or she would otherwise face. These include lack of the connectivity needed to serve rich media to many viewers, lack of hardware and software resources to convert files and serve rich content and the difficulty of transmitting files whole to each and every person requesting them. The present invention allows anyone on a network to easily deliver rich media over the network.

For larger and smaller players alike, the present invention solves the problem of a lack of knowledge among other network participants that they exist, a lack of knowledge among other network participants of where they can be found, their lack of software to assemble rich media files into a channel and their inability to password protect content, create the look and feel of the channel, charge for content, sell other goods and services on the channel and use the other features that the invention makes possible. Much like lockers in a gymnasium, the invention protects private property while allowing users to come together for a common pursuit.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not indented to limit the present invention solely thereto, will best be understood in conjunction with the accompanying drawings in which:

FIG. 1 is a block diagram of the system hardware architecture of the present invention;

FIG. 2 is a block diagram of the system software architecture of the present invention;

FIG. 3 is a flow chart describing the operation of the present invention;

FIG. 4 is a diagram of how multimedia is transferred to a central server;

FIG. 5 is an image depicting the Personal Producer software;

FIG. 6 is a screen shot showing links permitting search of multimedia files by keyword as well as browsing by categories;

FIG. 7 is a screen shot of a Personal Video Channel;

FIG. 8 is a screen shot of a Personal TV Channel;

FIG. 9 is a screen shot of a page of Personal Channels with tools to search for channels;

FIG. 10 is a list of Personal Channels;

FIG. 11 is a screen shot of Media Mogul software for managing a Personal Channel;

FIG. 12 is a screen shot of Media Mogul for managing multimedia that includes making files pay-per-view or password protected;

FIG. 13 is a screen shot of Media Mogul for setting a variety of properties of multimedia files including description, title and thumbnail image;

FIG. 14 is a screen shot of Media Mogul for linking to files from other web pages;

FIG. 15 is a screen shot of Media Mogul that shows how the software enables people to easily publicize content by sending video mail to contact lists;

FIG. 16 shows is a screen shot of Media Mogul for sending multimedia to individual contact;

FIG. 17 is a screen shot of Media Mogul for maintaining lists of publicity and other contacts;

FIG. 18 is a diagram showing how the software can provide audience tracking measures;

FIG. 19 is a table showing how Media Mogul provides security and digital rights management settings; and

FIG. 20 is a table showing how Media Mogul permits indexing of video using voice recognition technology, search of video by word and remote editing of video.

### DETAILED DESCRIPTION OF THE EMBODIMENTS

The present invention comprises a method for a company, group or individual to easily and advantageously transfer multimedia files to a central server where they can be readily accessed by others on the network. In accordance with an embodiment of the present invention, users can create and publish multimedia to a wide audience in seconds, a task that formerly might have taken weeks or, indeed, been impossible to achieve. Once the multimedia is published, an embodiment of the present invention further provides integrated tools to manage, publicize, edit, charge for and control access to the multimedia. Elements comprising an embodiment of the present invention include the Personal Producer software, Media Mogul software, V-Mail software, Personal Channels, Business Channels, Personal Stores and other software.

In accordance with an embodiment of the present invention, users process and transmit their multimedia files to a central server which, in turn, executes a chain of processes. The present invention has the beneficial effect of greatly increasing the value of the multimedia assets by making them available to others on the network, by optimizing them for transmission over a network and by giving the user a highly granular level of control over how the files are displayed and accessed by the audience thus secured.

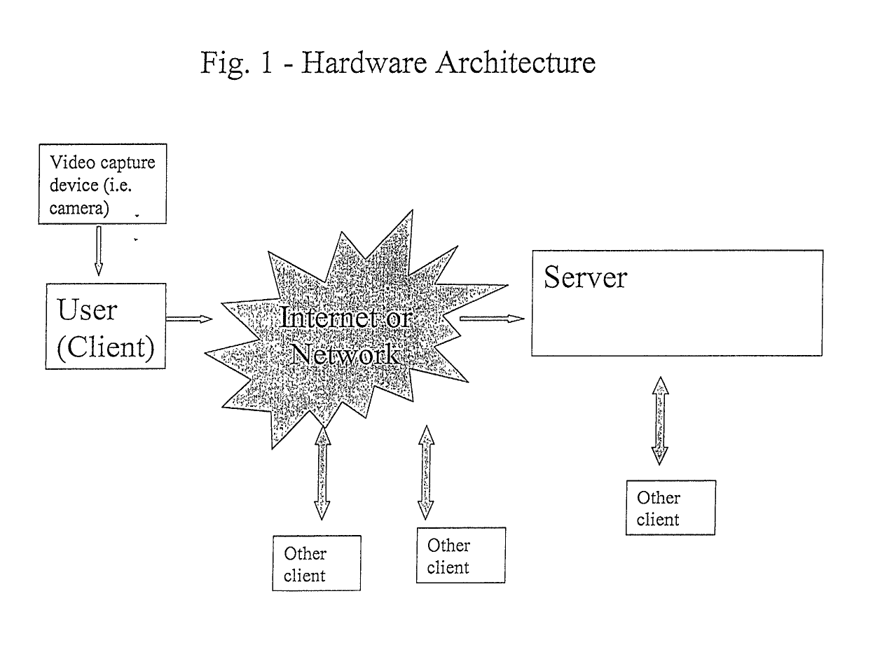

FIG. 1 illustrates the system hardware architecture of the computer network of the present invention. The hardware elements comprise an audio or video device such as a camera which the user or client first employs to capture the multimedia, the user's computer incorporating an audio or video capture card or equivalent software that converts the multimedia to a file on that computer, a network card or modem to connect the user's computer to a network and transfer the file to the central server and finally the central server. The server is connected to all of the other clients on the network.

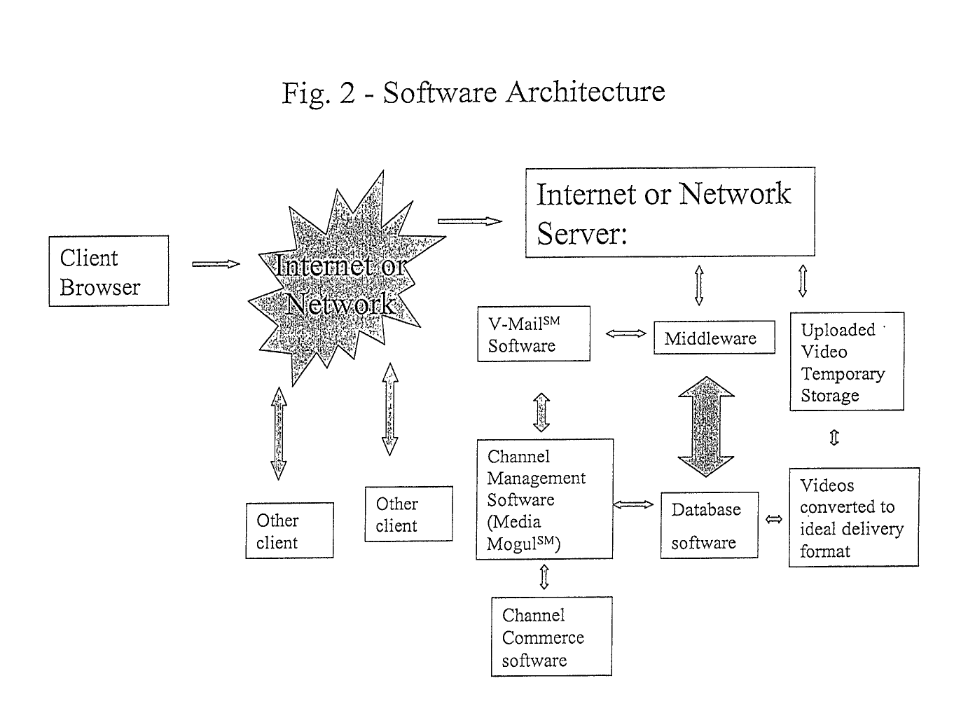

FIG. 2 illustrates the system software architecture. The software architecture is comprised of software operable with the audio or video capture card that converts the signal from a microphone, camera or related device into a digital file. This software is not shown but is commonly bundled with audio and video capture cards. In addition, some computers (as well as digital cameras) come with a built in ability to digitize an audio or video signal.

The next element of the software architecture is the user's Internet browser or client software (such as the AOTV Personal Producer) that connects through the Internet with the network server and other software residing on the central (hardware) server.

In turn, the software on the server is comprised of the Internet (or network) server and programming that interacts with the server. The latter includes middleware that connects the server to database software and enters data captured from the user into the database, the database software itself, software that receives and processes files uploaded to the server, software that gleans information from uploaded files and software that, based on that information, processes, sorts and stores files for efficient broadcast over the network.

Additional software that resides on the server, known as Media Mogul software and discussed in greater detail below, permits the user to control his Personal Video Channel^{SM} and all of the multimedia files brought together on this channel, once the files are loaded onto the server. This software, working in conjunction with the database software, permits users to set pay-per-view prices for viewing files, adjust the look and feel of the channel, password protect content and otherwise manage their channel. It also automatically charges viewers who elect to view pay-per-view programs and credits suppliers of the programming. For example, the user can use the pricing module of the Media Mogul software to set the pay-per-view prices and the collection module of the Media Mogul software to collect payment information from the viewer, such as bank account number, credit card number, debit card number, smart card information, debit a viewer's account and credit user's account established with the service provider, etc.

Other software allows viewers to comment on whether a video is worth the price with channel owners having the choice whether to enable or disable this feature on their channels.

Additional V-Mail(SM) software residing on the server, in conjunction with MediaMogul software, allows channel owners to advantageously, quickly publicize their software, schedule broadcasts and events and otherwise bring viewers to their channel by sending out links to their channel and video by e-mail in multiple formats. For example, they can send out simple e-mails inviting people to view a video, send a social or corporate invitation to an invitation-only or password-protected video (that may be scheduled for a certain time) or send a greeting card with a self loading video. Video chat software (i.e. V-Chat^{SM} software lets people chat directly with one another using multimedia. Finally additional commerce tools such as the V-store software allows channel owners to use the video to sell goods and otherwise perform commerce using multimedia to illustrate products and services.

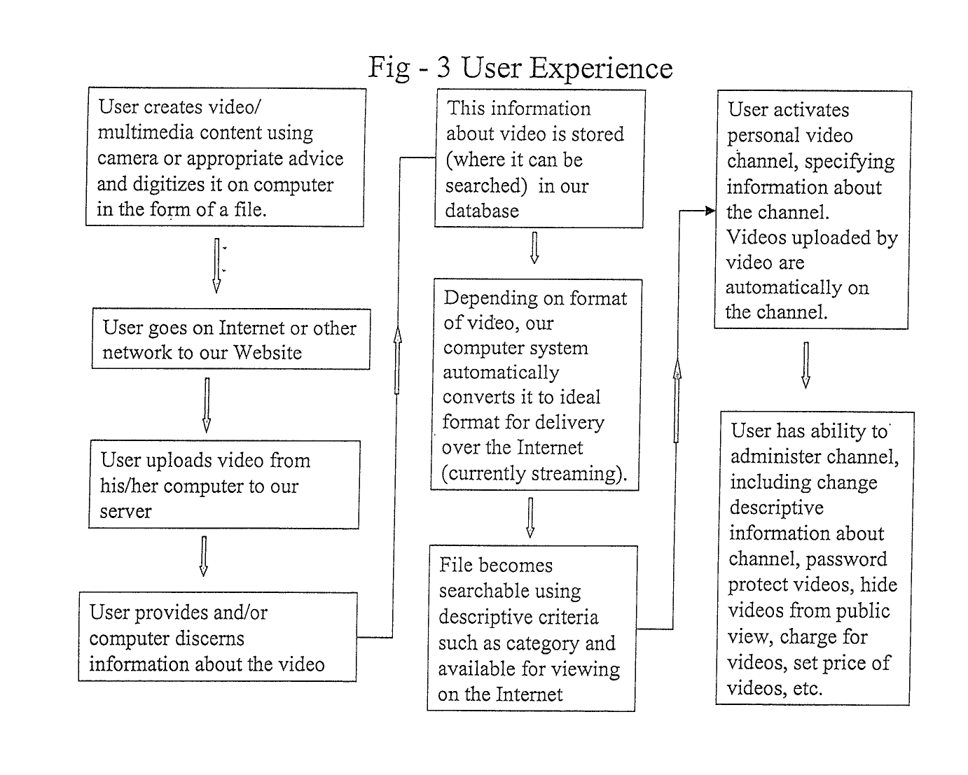

FIG. 3 shows the experience from the point of view of the user. The user first captures video of multimedia using the appropriate device (such as a camera or video cassette recorder) in the form of a digital file. In the case of older analog devices such as tape recorders and cameras, this involves recording the multimedia and then capturing it on a computer in digital format. Newer devices capture it directly in digital form.

Next, the user transfers the file to his or her computer. Then the user transfers the file to a centralized server using either client side software such as the Personal Producer or via a browser connection with the server over the network. Once in communication with the server, the user enters descriptive information about the multimedia. (During this process, additional information about the file is also automatically gleaned.) Using the client side software, if present, or if not present, software residing on the server, the file is converted into ideal form for delivery over the network. Using the descriptive information provided by the content provider or gleaned from the multimedia itself, the multimedia can be found by others through search or by browsing and subsequently viewed.

As part of the overall multimedia publishing system, users can advantageously activate a Personal Channel™, Personal Store or other virtual space for displaying multimedia with several clicks of a mouse. The multimedia he or she has uploaded automatically appears on their channel and the user can set the title of the channel, its description, its look and feel and other channel-wide properties. Using this software what would otherwise require days of labor and a significant outlay can be accomplished in seconds.

Using Media Mogul multimedia management software, the user can also set individual properties for each multimedia file including whether to hide or display it, whether to password-protect it and the password, whether to charge others to view it on a pay-per-view basis. They can also enable or disable a function which lets others rate pay-per-vides vis a vis the cost.

In turn, they can activate commerce functions of their channel, if they desire, turning it into a video store so that the multimedia can be used to sell goods or services

They can use V-Mail^{SM} software through a browser interface to publicize the channel, invite others to password protect screenings, send a video greeting card to others or otherwise enable more people to view their video.

### Transfer of Multimedia to a Central Server

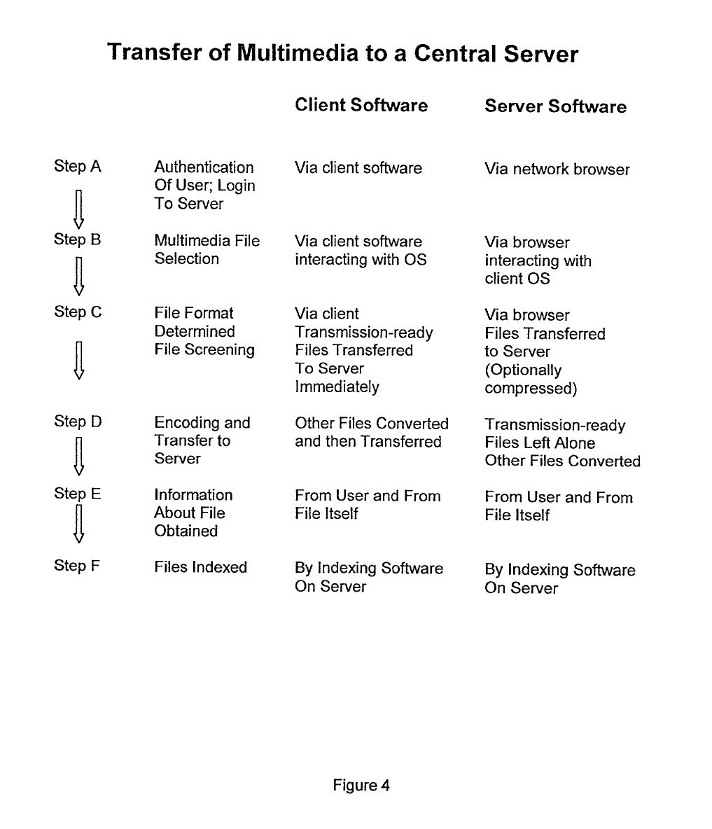

In accordance with an embodiment of the present invention, FIG. 4 illustrates how video is transferred to the server.

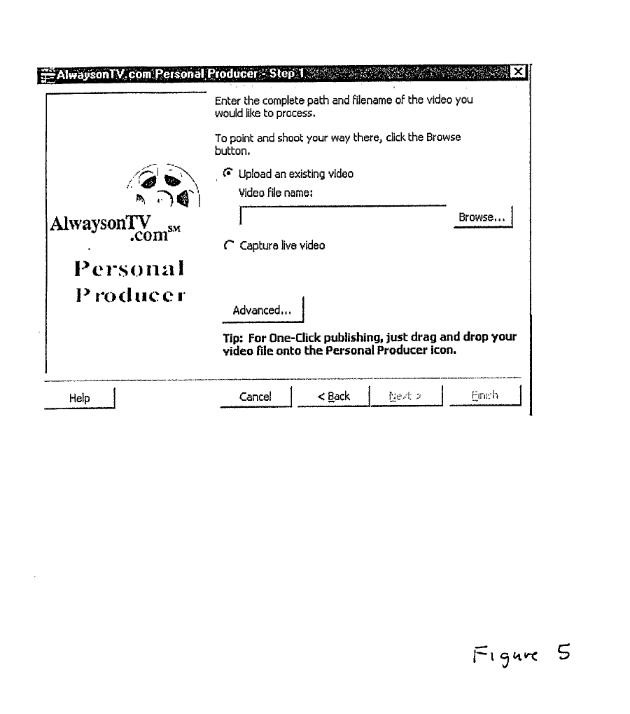

Three principal methods of electronically transmitting the files are possible. They include i) invoking client software such as the Personal Producer software shown in FIG. 5 which handles the encoding and uploads locally; or ii) invoking a browser plug in that handles encoding and transmits locally through a browser interface or iii) by communicating through a browser directly with the server which handles the encoding and uploading on the server side.

Steps are as follows:

Step A.

The User having established an account, first authenticates his identity by logging in. This is done either through the browser with the server or, if client software is employed, through the client software which communicates with the server. In the latter case, user identity and password information can be stored on the local computer and need only be entered once.

Step B.

After authenticating user identity, the software, whether client or server-side, then prompts the user to specify a multimedia file to place in the system. The user may type in the file name or “browse” to the directory where the file is contained and then click to select it. An additional option, available when the Personal Producer software is used, is for the User to drag and drop a file onto the Personal Producer icon which automatically launches the software and immediately beings processing the file in question.

Step C.

Whether client or server side software is used, once a file is selected, the software examines its format. At this point it performs a check to screen out in valid files, i.e. those which are not valid multimedia content, such as executable computer programs.

Step D.

When client-side software is present, once the software knows the format of the file, if the file is in a format ready for transmission over the Internet, the software immediately begins transferring the file to the server. A progress bar and meter keep the user abreast of the progress of transfer and conversion. Optionally, the software may compress the file before transfer. If the file is not in an ideal format, the software encodes or transcodes the file into an optimized format and then transfers the file to the server. This generally has the additional benefit of reducing file size, speeding up transfer. Once on the server, the file is automatically moved to the appropriate directory for transmission across the network.

In the case of server side software, after screening out invalid files, the software draws the file up to the server. There it distinguishes between those files which are ready for transmission and those which require transcoding. Files ready for transmission are moved to the appropriate directory for transmission. Files which require encoding are converted and then moved to the appropriate directory for transmission. A progress bar and meter keep the user abreast of the progress of transfer and conversion.

Step E.

Whether client or server side software is used, once the file is on the server, the user is prompted for information about it such as a title, description, preexisting category or new category, rating (i.e., whether the content is mature or inappropriate for children) and information about it such as whether it should be password protected (and, if so, what the password should be), available only on a pay-per-view basis (and, if so, what the price should be), copiable, “blacked out” (or barred from certain regions, domains or IP addresses) watermarked, made available for viewing for a limited time only, non-forwardable as well as other information describing it and limiting how it may be accessed. The black out feature has the highly advantageous quality of enabling content owners to broadcast to a geographic area, set of users such as those connecting via an ISP such as aol or earthlink or preclude viewing in a geographic area. Other information such as file size, bandwidth requirements, frame rate, frequency information, length, copyright status, digital rights management parameters, authorship, date of creation, rating, other metadata previously entered are gleaned from the file itself. These are all stored in a database so that they can be displayed with the file or used to retrieve files or used in setting display and access restrictions.

Finally, if desired, the user can instruct the multimedia file to be run through an in-line video indexer that performs voice and shot recognition, indexing the video word by word and frame by frame. This software automatically makes a transcript of the video and stores keyframes. Video indexed in this way can then be searched by keyword. Normally, this advanced technology would not be available to the vast majority of video producers and video producers could arrange for the manual indexing of their video only at great expense. The ability to do this remotely with a simple instruction provides great utility to distributed producers of multimedia content and vastly increases the value of their video assets.

Such indexing also makes possible remote editing of scenes. In this embodiment, at the command of the user, small images or “keyframes” of each scene are displayed on an editing screen. The user can then click on each in order to create a list of frames, thus rearranging the sequence of frames or scenes, permitting “point and click” remote video editing. This brings easy to use video editing tools to people who otherwise might not have them.

### Display of Multimedia

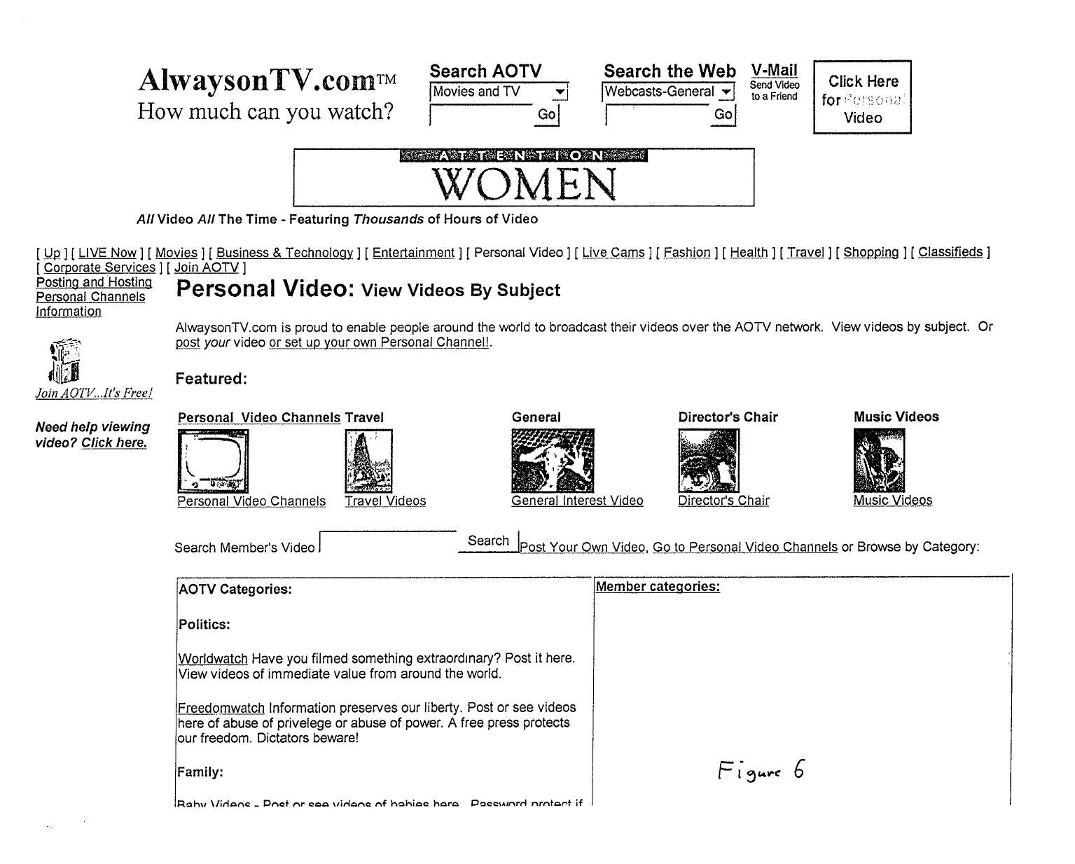

Files so transferred to the server can be accessed in two broad ways. First they can be accessed individually, such as by category, through search tools that search for keywords or other parameters such as name, multimedia supplier, in what parts of the world the files are viewable, whether they are freely available, password protected, available pay-per-view and so forth. FIG. 6 shows a browser screen with links permitting search of multimedia files by keyword as well as browsing by categories.

Second, multimedia transferred to the central server can be accessed through an exhibition space created by the user.

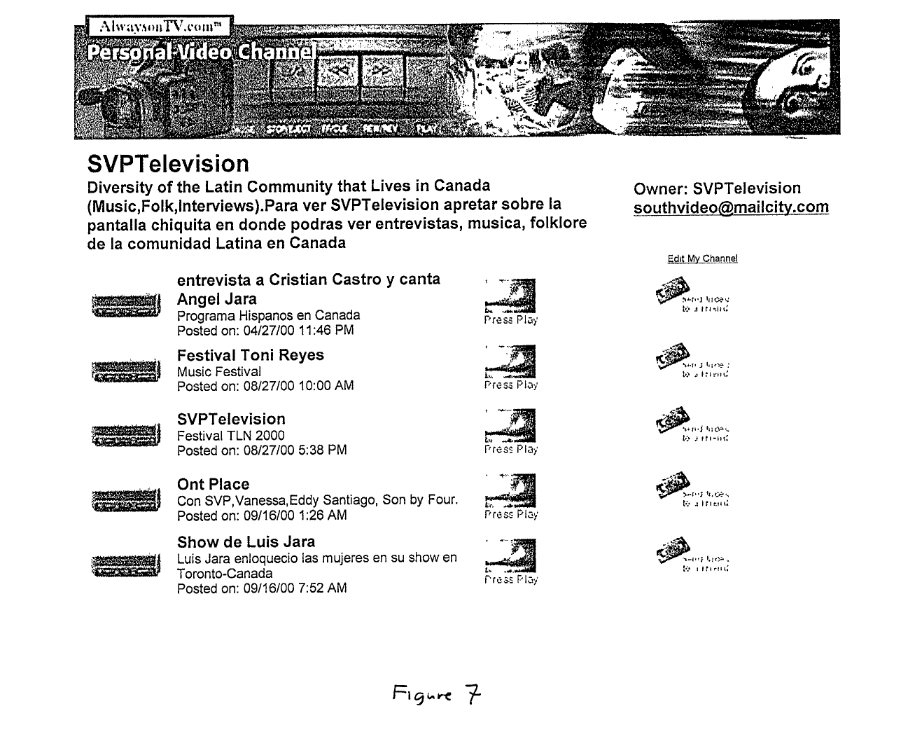

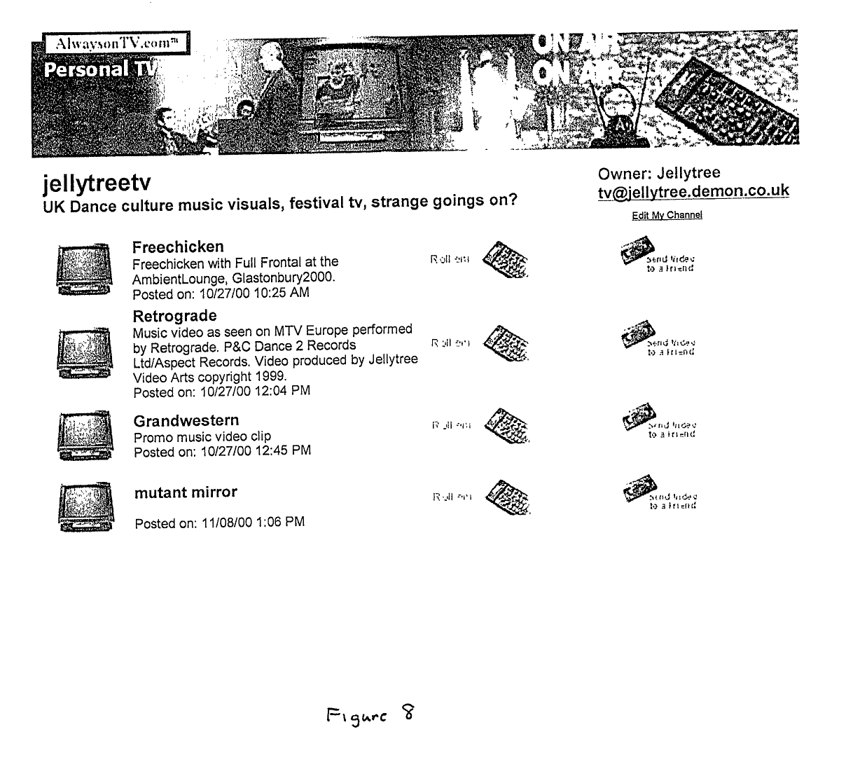

These exhibition spaces called “Personal Video Channels™” Personal TV Channels™, Personal Movie Channels, Pay-Per-View Theaters, Business Channels, Business Networks, Personal Stores or by other names are dynamically created virtual spaces that permit content providers to bring multimedia they have transferred to the server together in one place, control how the multimedia is displayed or accessed and then use the video for entertainment, education, training, marketing, commerce or other uses. FIG. 7 depicts an embodiment of the Personal Video Channel of the present invention. FIG. 8 depicts an embodiment of the Personal TV Channel of the present invention having a different look and feel.

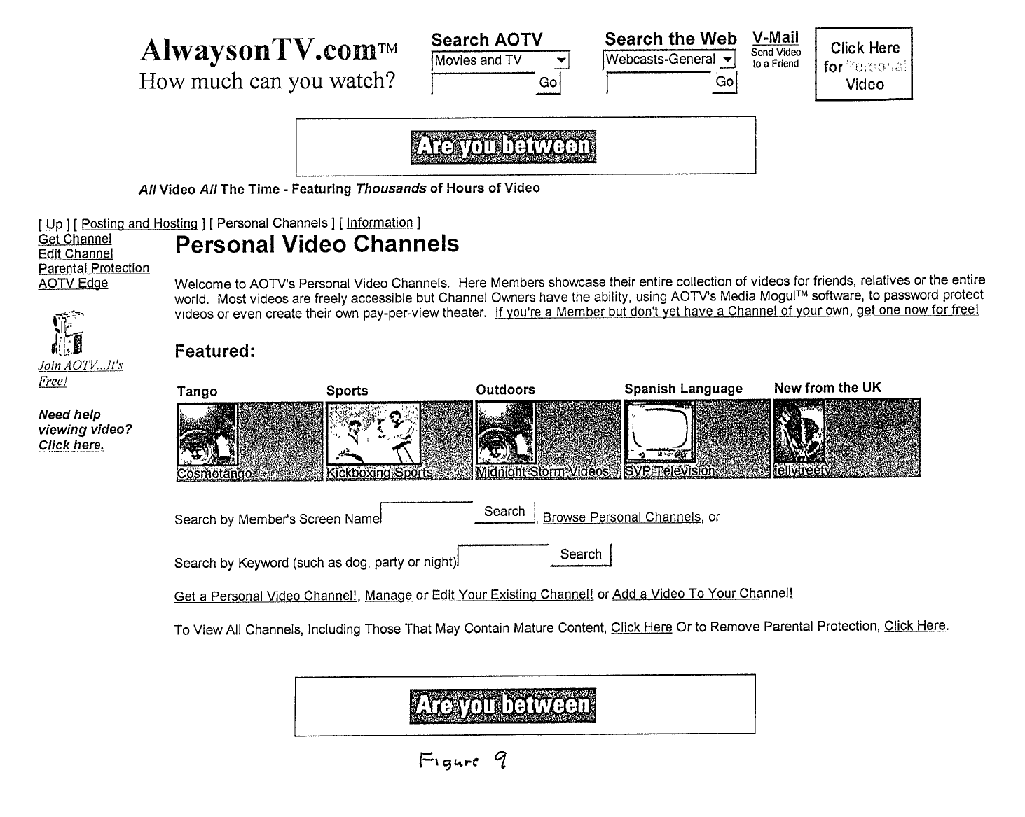

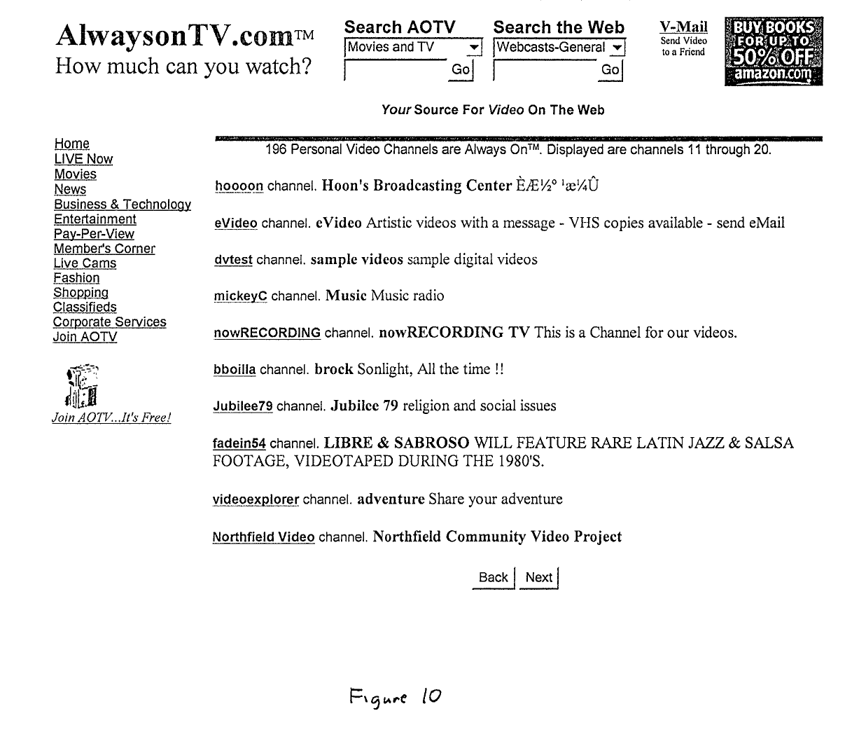

These spaces first serve the purpose of grouping videos supplied by one person together. One person can place all of his or her videos on one channel, or optionally, place them on different channels with different titles or themes as he or she prefers. In addition, when Channels themselves are brought together in one place, they provide the additional benefit of further organizing videos that would otherwise be impossible to find by enabling viewers to choose, using among Channels which themselves organize videos. For example, FIG. 9 shows a page that highlights five channels and provides tools to search channels by keyword and FIG. 10 shows a list of Channels available for browsing. Preferably, Channels generally have themes, allowing viewers to find a collection of videos they may want to view quite rapidly.

Once the videos are so grouped, the owner of the channel can use a variety of tools embodied in the Channel management software, known as Media Mogul software, to determine what is presented to the viewers.

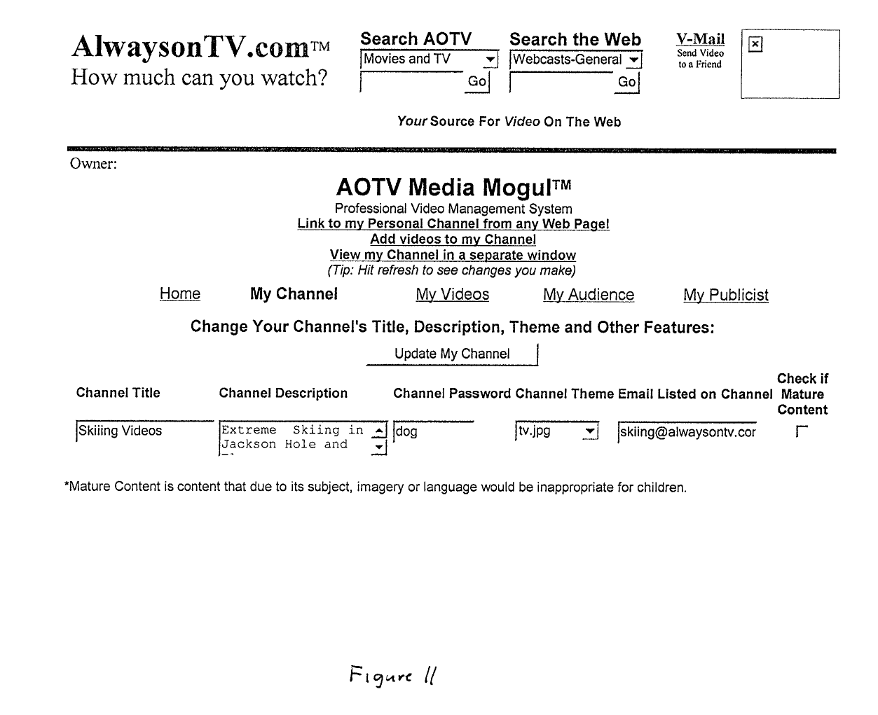

For example, FIG. 11 shows how Media Mogul multimedia management software allows viewers to adjust the look and feel of their Channel. Variables include the overall theme, such as video, television or movies, the title of the channel, the description of the channel and the rating of the channel. In another embodiment of the present invention, users cans elect from literally dozens of different designs and rearrange their channels across multiple pages in myriad ways.

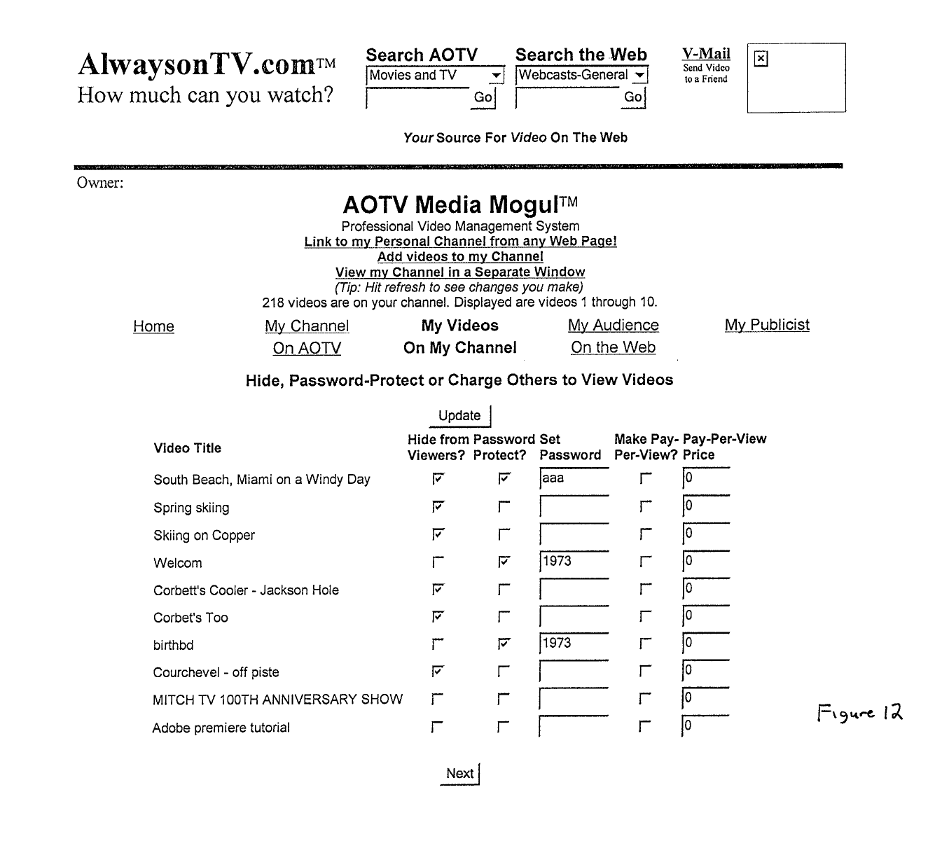

FIG. 12 shows an example of how the Media Mogul multimedia management software lets them charge viewers to view content, password protect content, hide content from viewers or restrict access to content. Other properties the software may be set to control include restriction of access on the basis of domain, age, IP address, country, geographic area, GPS region or other criteria.

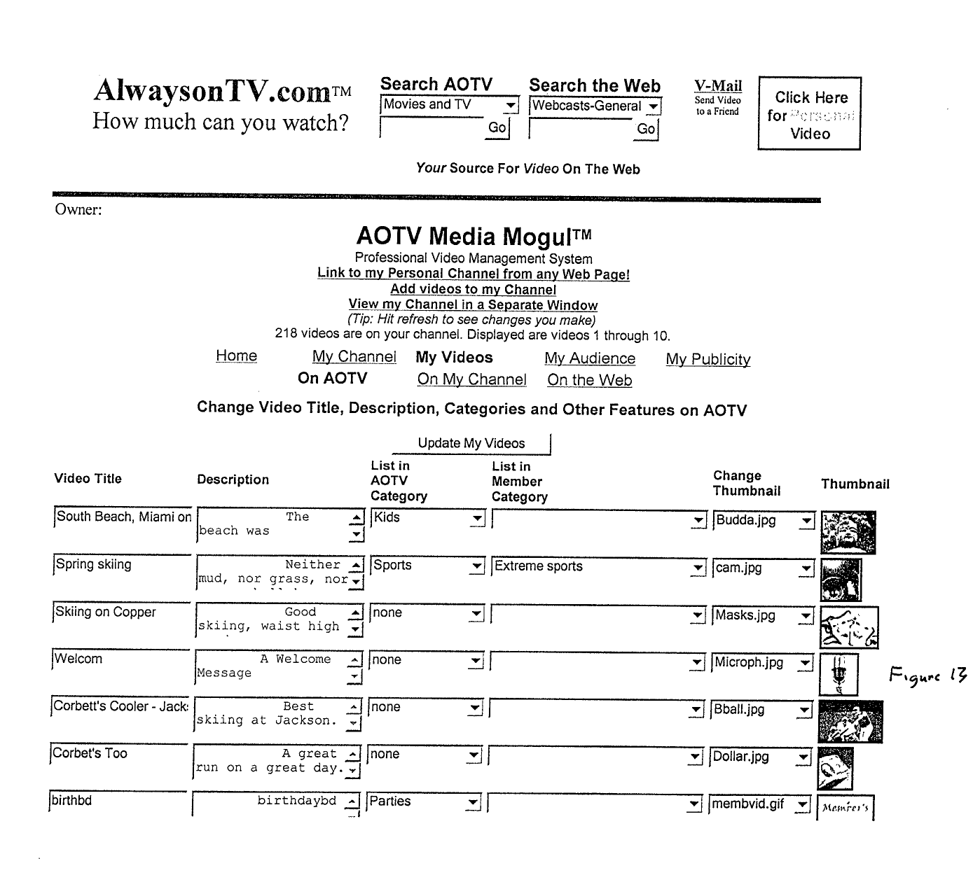

FIG. 13 shows an example of how the Media Mogul multimedia management software allows people to change a variety of properties associated with a multimedia file including its title, its description, the thumbnail associated with a video and other parameters.

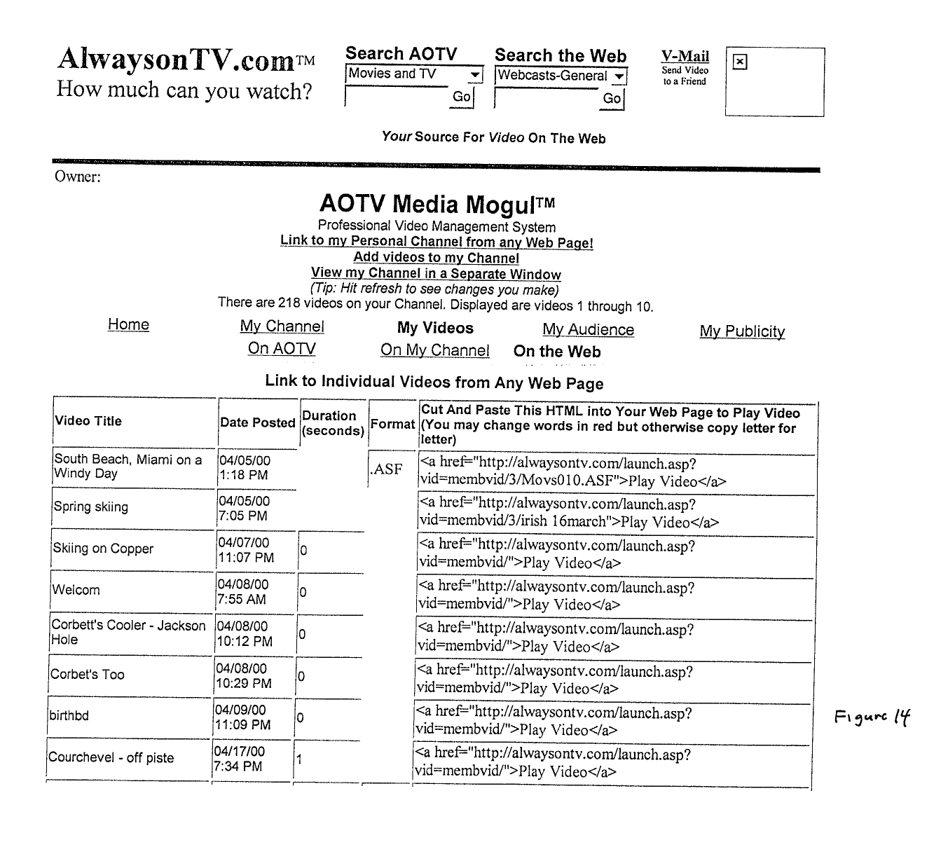

FIG. 14 shows an example of how the Media Mogul multimedia management software enable people to link to individual video files. This feature advantageously allows the personal channel system to serve as a “back end” for multimedia on other websites or pages.

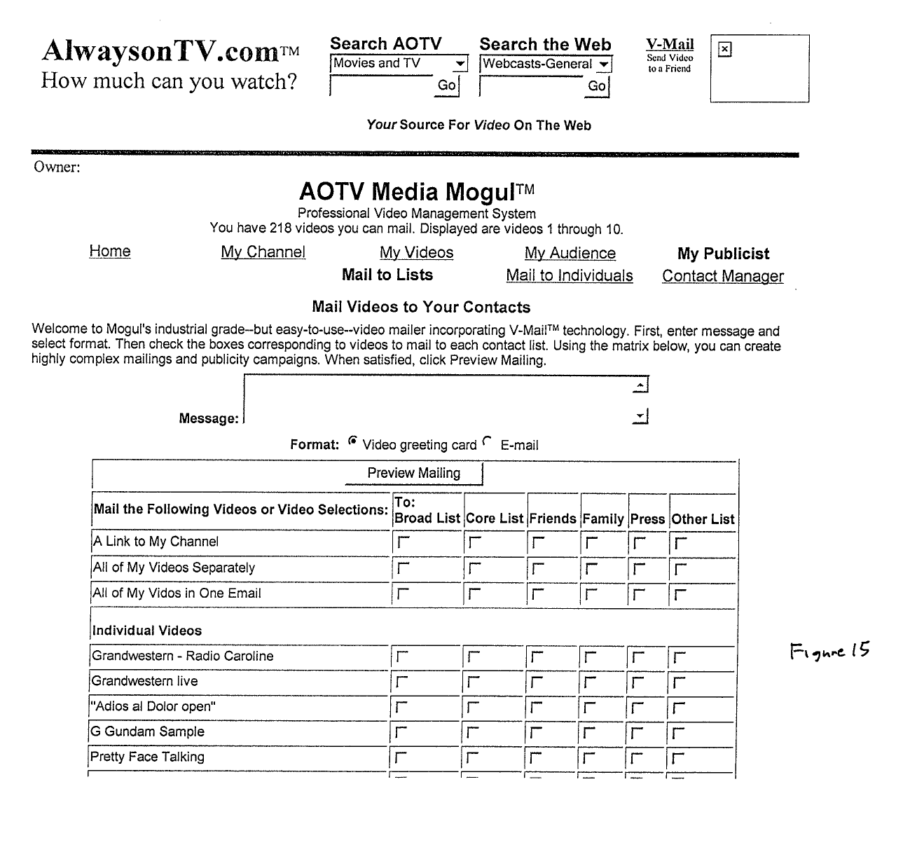

FIG. 15 shows an example of how the Media Mogul multimedia management software enables people to easily publicize content by sending video mail to contact lists. In accordance with this embodiment, users can create contact lists and then send mailings of multimedia to those lists with a single mouse click.

Video mail can brings viewers to the channel and moves the channel's content into viewers' email in-boxes or to their personal computing devices such as a cell phone, PDA or Palm Pilot, advantageously increasing the reach and value of the channel.

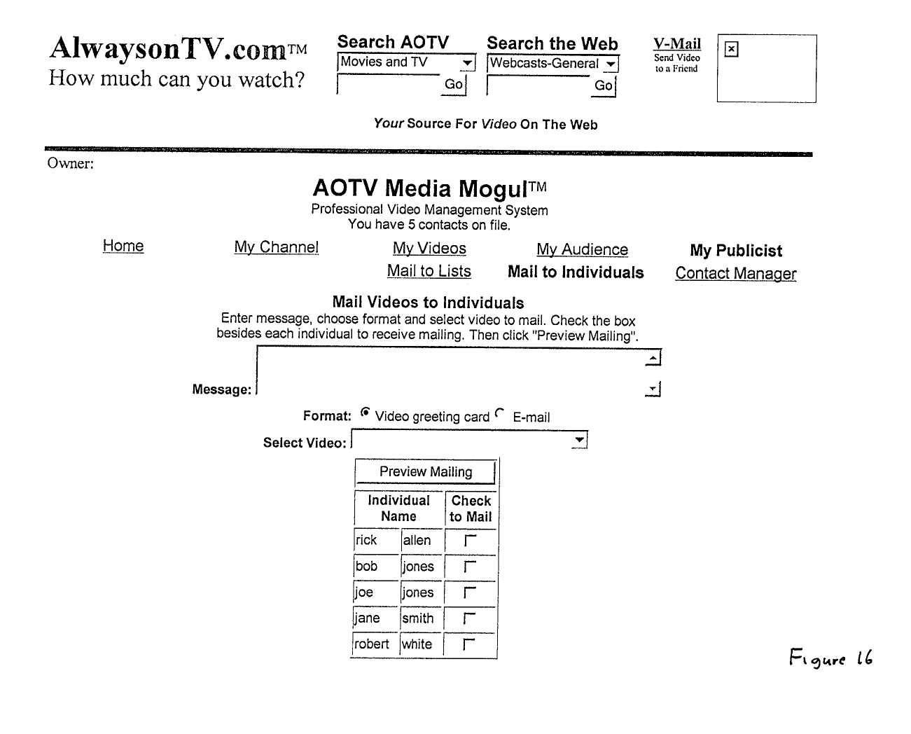

FIG. 16 shows an example of how the Media Mogul multimedia management software enables people to easily send videos to individual contacts. In accordance with this embodiment, users desiring to send a quick mailing to one individual can accomplish this in seconds.

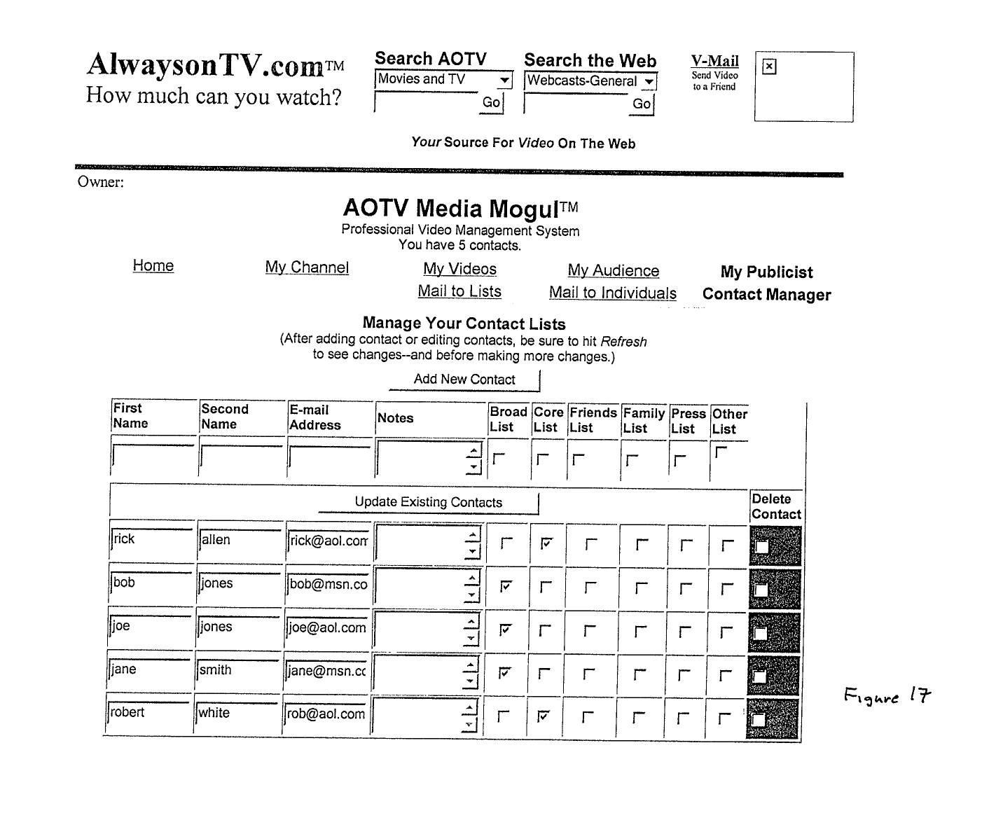

FIG. 17 shows an example of how the Media Mogul multimedia management software enables people to maintain lists of publicity contacts. These lists permit powerful publicity efforts that would otherwise be unavailable to producers of multimedia content.

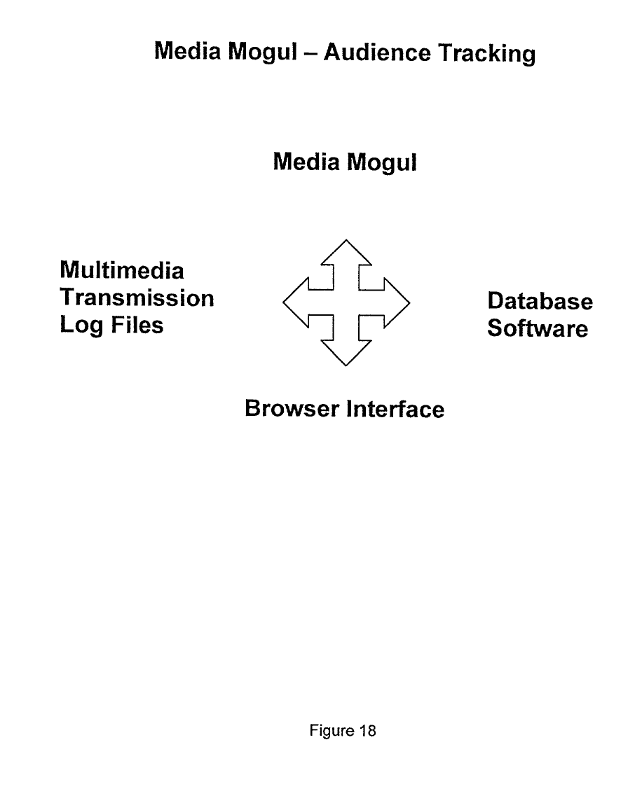

FIG. 18 is a diagram showing an example of how the Media Mogul multimedia management software, such as the measuring module, can provide audience tracking measures or viewership such as views, views by region, views by domain, bandwidth transferred, most popular hours of the day and so forth.

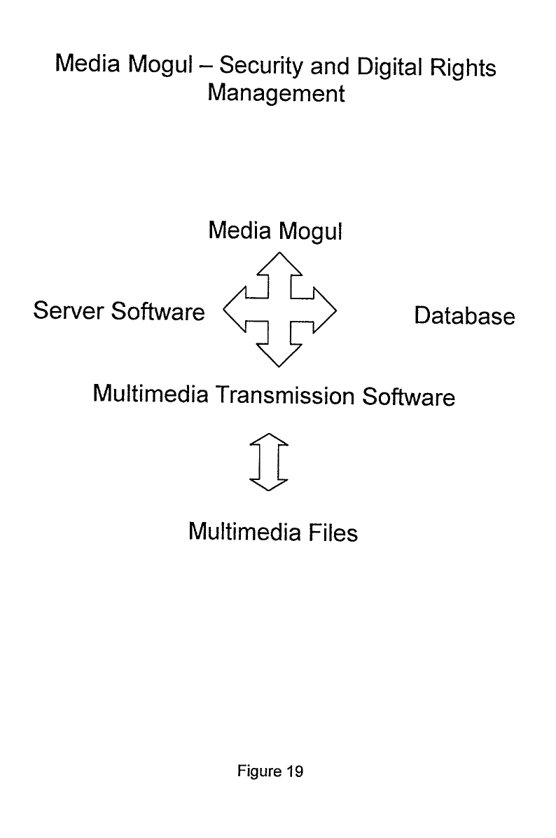

FIG. 19 is a table showing an example of how Media Mogul multimedia management software provides security and digital rights management settings. This permits content owners to selectively microcast or tailor a broadcast with a level of granularity not previously available. This feature also permits content owners to support complex rights allocations.

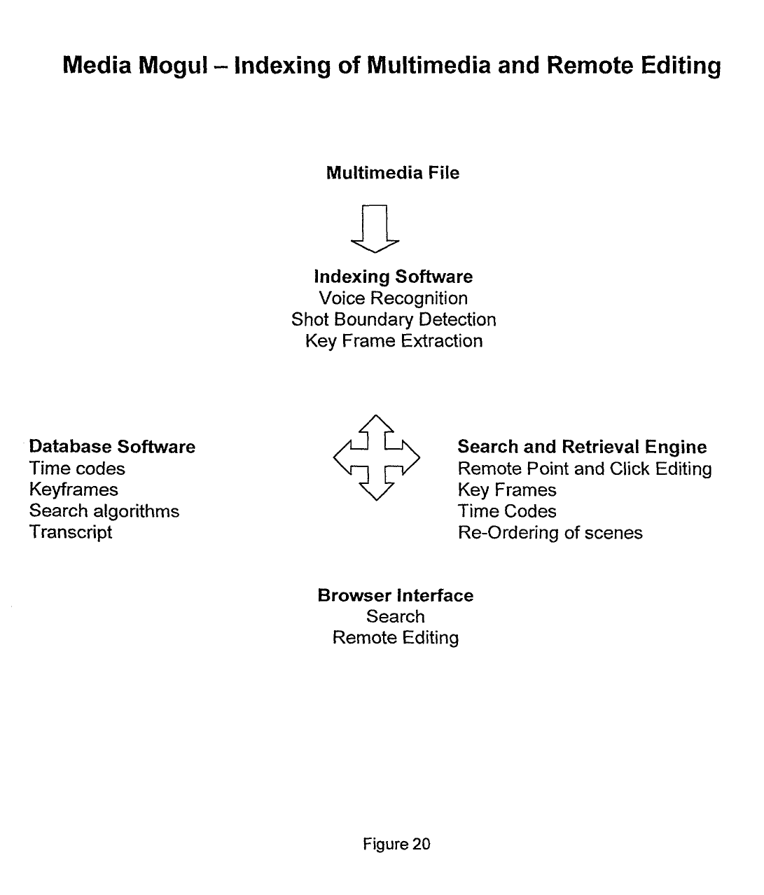

FIG. 20 is a table showing an example of how Media Mogul multimedia management software permits indexing of video using voice recognition technology, search of video by word spoken by a user and remote editing of video by verbal command or instruction. If a user elects this embodiment of the present invention, the user can instruct a file to be run through an in-line video indexer that performs voice and shot recognition, indexing the video word by word and frame by frame. This software automatically makes a transcript of the video and stores keyframes. Video indexed in this way can then be searched by keyword. Such indexing also makes possible remote editing of scenes. In this embodiment, at the command of the user, small images or “keyframes” of each scene are displayed on an editing screen. The user can then click on each in order to create a list of frames, thus rearranging the sequence of frames or scenes, permitting “point and click” remote video editing.

In short, using the invention, once multimedia is placed on a centralized server and files are brought together in one virtual place, the files become available to viewers across the entire network, subject to restrictions the provider of the video is now able to easily impose. Each channel is controlled by the person or entity who created it. Yet channel owners benefit from the externalities of their proximity to a large number of other channel owners as a combination of a large number of channels serves as a greater magnet for potential viewers.

The following examples illustrate the advantages of the present invention:

(a) Consider a young jazz musician looking for away to publicize his music inexpensive way to distribute videos of his most recent concerts. He has a collection of tapes of concerts and a Web-site that is limited to text and pictures. While he could post a video to the website, but can't afford to hire someone to add a video feature directly to the site. Moreover, he would like to increase traffic on the site, but can't afford costly search engine listings or advertising. He wants to protect the content from copyright infringement by using a password. The password effectively would put a fence around the content and allow him to prevent others from exploiting it for commercial gain.

(b) Let's take the case of the local public access cable show that would like to reach a broader audience with its programming, but doesn't have the time or money to add a video feature to its own Web-site. It is particularly interested in reaching viewers who have a connection to the community the station covers and therefore want to stay in touch even though they are far away, i.e., college kids or others who have moved temporarily from their hometown but are loyal fans of the hometown chamber orchestra, football team or city council and want to have access to coverage of these events particularly on-demand. On demand, because this is not the viewer's top entertainment or news priority in terms of timeliness. Instead the viewer wants access to an archive of regular shows.

(c) Let's take the example of a conference planner who is looking for a cost effective way to show clients videos of locations and hotels that are available as venues and of possible speakers. This would save her time and money and reduce the expenses she has to pass along to her customers. She would like to use a hosting site that would allow her to link directly to her own page and market that specifically.

(d) Let's take the example of a small law school. The school has developed a very high quality seminar program. Practitioners as well as students who were unable to attend would also be interested in seeing the programs. Currently, they are available on video cassette, but this is expensive, difficult to administer and not in real time. The school would like to post the video on the Web for on demand viewing and would like to charge a small fee of viewers who are not associated with the school. It does not have the resources to do this on its own and is looking for a low cost, flexible solution.

(e) Let's take the example of the local furniture store that thinks customers would find it much easier to assemble the bookshelf they just bought if there was a demonstration on video that they could access on-demand from home. Until now that hasn't been realistic because it was too expensive to hand out videos to each customer and because the customer wouldn't necessarily have the equipment at home to view the video. Today, customers with a PC at home would be able to access streaming video. The store is looking for a site that will host it's “How To” videos. The store wants to be able to password protect its content on the site so that competitors won't be able to access and piggy-back on the store's efforts. In addition, the password is a marketing tool in that the store can use as a “give-away”. It also builds the relationship between the store and the customer, both in practical terms but also symbolically—the buyer is “initiated” into an elite membership club with real benefits.

(f) Finally, let's take the example of the young family that just had a baby. Grandma and grandpa, and a myriad of aunts and uncles located all over the U.S. want to get videos of the baby. It's very expensive and time consuming to get this done. And by the time it's done, the baby is in college! Instead, the family the family would like to post their home videos on the Web with access for family members only. They don't want to set up their own Web-site. They actually don't even have a computer.

While the present invention has been particularly described with respect to the illustrated embodiment, it will be appreciated that various alterations, modifications and adaptions may be made based on the present disclosure and are intended to be within the scope of the present invention. It is intended that the appended claims be interpreted as including the embodiment discussed above, those various alternatives which have been described and all equivalents thereto.

1. A method of managing multimedia files on a communications network, comprising the steps of:
uploading multimedia files to a central server configured to broadcast multimedia over said network;
indexing said multimedia files according to descriptive information to categorize said multimedia files by subject; and
organizing said multimedia files on user's personal video channel, wherein said user can password-protect said multimedia files, and edit and administer said user's personal video channel.

2. The method of claim 1, further comprising the steps of setting prices to view said multimedia files by viewers, and collecting a fee when a viewer views said multimedia files on said personal video channel.

3. The method of claim 2, wherein said multimedia files are pay-per-view programs and wherein the step of collecting debits an account of said viewer when said viewer views a pay-per-view program on said user's personal video channel and credits an account of said user.

4. The method of claim 3, further comprising the step of transmitting comments of said viewer to said central server.

5. The method of claim 1, wherein said personal video channel supports e-commerce activities to enable said user to market and sell goods and services on said personal video channel.

6. The method of claim 1, wherein said personal video channel supports video mail so as to permit said user to publicize said personal video channel and hold pay-per-view or invitation-only screenings.

7. The method of claim 1, wherein said personal video channel supports video chat so as to permit viewers to hold discussions about said personal video channel and to share multimedia files.

8. The method of claim 1, wherein said multimedia files represent videos and said videos can be edited remotely.

9. The method of claim 1, further comprising the steps of measuring the viewership of said multimedia.

10. The method of claim 8, further comprising the steps of indexing such videos by a verbal word spoken by a user, such that each video can be searched and edited in accordance with a verbal command or instruction.

11. A system for managing multimedia files on a communications network, comprising:
a central server for storing uploaded multimedia files from users over said network and for broadcasting said multimedia files over said network;
an indexer for indexing said multimedia files according to descriptive information to categorize said multimedia files by subject; and
a personal video channel for organizing said multimedia files by a user, wherein said user can password-protect said multimedia files, and edit and administer said user's personal video channel.

12. The system of claim 11, further comprising a pricing module for setting prices to view said multimedia files by viewers, and a collecting module for collecting a fee when a viewer views said multimedia files on said personal video channel.

13. The system of claim 12, wherein said multimedia files are pay-per-view programs and wherein the collecting module debits an account of said viewer when said viewer views a pay-per-view program on said user's personal video channel and credits an account of said user.

14. The system of claim 13, wherein said central server is operable to receive comments from said viewer.

15. The system of claim 11, wherein said personal video channel supports e-commerce activities to enable said user to market and sell goods and services on said personal video channel.

16. The system of claim 11, wherein said personal video channel supports video mail so as to permit said user to publicize said personal video channel and hold pay-per-view or invitation-only screenings.

17. The system of claim 11, wherein said personal video channel supports video chat so as to permit viewers to hold discussions about said personal video channel and to share multimedia files.

18. The system of claim 11, wherein said multimedia files represent videos and said videos can be edited remotely.

19. The system of claim 1, further comprising a measuring module for measuring the viewership of said multimedia.

20. The system of claim 18, wherein the indexer is operable to index said videos by a verbal word spoken by a user, such that each video can be searched and edited in accordance with a verbal command or instruction.
